(19) United States
(12) Patent Application Publication
(10) Pub. No.: US 2009/0051481 A1
(43) Pub. Date: Feb. 26, 2009

(54) REMOTE CONTROLLER FOR PROVIDING MENU AND METHOD THEREOF

(75) Inventors: Joo-hoon Park, Seoul (KR); Ju-hyun Ko, Siheung-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/039,020

(22) Filed: Feb. 28, 2008

(30) Foreign Application Priority Data
Aug. 23, 2007 (KR) 10-2007-0085017

(51) Int. Cl. G08C 19/00; G06F 13/42

(52) U.S. Cl. 340/2.1; 340/825

(57) ABSTRACT

A remote controller for providing at least one menu to control a plurality of external apparatuses is provided. The remote controller includes a display, a sensor which senses a gripping direction of the remote controller, and a controller which displays at least control menu of one of the plurality of external apparatuses on the display according to the sensed gripping direction.

### CROSS-REFERENCE TO RELATED APPLICATIONS

This application claims priority under 35 U.S.C. §119 from Korean Patent Application No. 10-2007-0085017, filed on Aug. 23, 2007, in the Korean Intellectual Property Office, the disclosure of which is incorporated herein by reference in its entirety.

### BACKGROUND OF THE INVENTION

1. Field of the Invention

Apparatuses and methods consistent with the present invention relate to providing a menu, and more particularly, to a remote controller for providing control menus to control a plurality of devices according to a gripping direction of a remote controller where a user grips the remote controller and a method for providing a menu thereof.

2. Description of the Related Art

Various electronic products such as televisions (TV), home theaters, digital versatile disc (DVD) players, videocassette recorders (VCR), air conditioners, and personal computers (PC), are now widely used. These electronic products typically have remote controllers for a user's convenience. Therefore, the average household has too many remote controllers.

As the number of remote controllers in a home increases, the indoor environment becomes more complicated, making it hard for a user to select a desired remote controller among the remote controllers. A universal remote controller has been developed to obviate this problem, which is compatible with various electronic devices.

As a panel of a related art universal remote controller has a plurality of control keys provided to correspond to each different electronic device, the universal remote cannot have various functions, and a user has to individually find a desired control key.

When a new electronic device is installed, or functions are added or deleted, the functions and menus stored in the universal remote should be modified accordingly. However, because the process of changing the functions and menus is complicated and difficult, it is inconvenient for users to manipulate the universal remote control.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

The present invention provides a remote controller and a method for providing menus thereof, in which control menus to control a plurality of apparatuses are provided according to a gripping direction, thereby improving a user's convenience.

According to an exemplary aspect of the present invention, there is provided a remote controller for controlling a plurality of external apparatuses, the remote controller comprising: a display; a sensor which senses a gripping direction of the remote controller in which a fore end of the remote controller faces; a controller which displays at least one of a plurality of control menus of one of the plurality of external apparatuses on the display according to the sensed gripping direction.

The display may comprise a first display which is formed on a surface of the remote controller; and a second display which is formed on an opposite surface of the remote controller, wherein the controller displays the one of a plurality of control menus of one of the plurality of external apparatuses corresponding to the sensed gripping direction on the first or second display that faces an upper surface of the remote controller.

The sensor may comprise a gravity sensor which senses a display that faces the upper surface of the remote controller from among the first and second displays; and a geomagnetic sensor which senses the gripping direction.

The remote controller may further comprise a storage unit which stores control menus of each of the plurality of external apparatuses, wherein the controller provides a setting mode to set the control menus of each of the plurality of external apparatuses as determined by the gripping direction, and if one of the external apparatuses is selected through the setting mode in the current gripping direction, the controller matches a gripping direction with the control menus of the selected external apparatus to store.

The gripping direction may comprise a first direction in the range of −45° to 45°, a second direction in the range of 45° to 135°, a third direction in the range of 135° to 225°, and a fourth direction in the range of 225° to 315°, with respect to the forwarding direction of the fore end of the remote controller, and the gripping direction may comprise a fifth direction in the range of −45° to 45°, a sixth direction in the range of 45° to 135°, a seventh direction in the range of 135° to 225°, and an eighth direction in the range of 225° to 315°, with respect to the forward direction of the reversed remote controller.

The remote controller may further comprise a plurality of signal transmitters which are provided on each of all the surfaces of the remote controller, and which transmit a control signal to the external apparatus corresponding to the gripping direction.

The display may be a touch screen panel.

According to another exemplary aspect of the present invention, there is provided a method for providing menus of a remote controller to control a plurality of external apparatuses, the method comprising: sensing a gripping direction of the remote controller in which a fore end of the remote controller faces; and displaying at least one of a plurality control menus of one of the plurality of external apparatuses according to the sensed gripping direction.

The displaying may comprise displaying the at least one control menu corresponding to the sensed gripping direction on a display corresponding to an upper surface of the remote controller among first and second displays provided on both surfaces of the remote controller.

The sensing may comprise first-sensing the display corresponding to the upper surface of the remote controller among the first and second displays; and second-sensing the gripping direction in which a fore end of the remote controller faces.

The method may further comprise providing a setting mode to receive the at least one control menus of the one of the external apparatus according to the gripping direction; selecting one of the plurality of external apparatuses through the setting mode in the current gripping direction; and matching the current gripping direction with the control menus of the selected external apparatus to store.

The gripping direction may comprise a first direction in the range of −45° to 45°, a second direction in the range of 45° to 135°, a third direction in the range of 135° to 225°, and a fourth direction in the range of 225° to 315°, with respect to the forwarding direction of the fore end of the remote controller, and the gripping direction may comprise a fifth direction in the range of −45° to 45°, a sixth direction in the range of 45° to 135°, a seventh direction in the range of 135° to 225°, and an eighth direction in the range of 225° to 315°, with respect to the forward direction of the reversed remote controller.

An input of the control menus to be displayed may be a touch screen manner.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram illustrating a remote controller according to an exemplary embodiment of the present invention;

FIG. 2 is block diagram illustrating the remote controller of FIG. 1 in detail;

FIGS. 3A and 3B are schematic diagrams illustrating a remote controller according to an exemplary embodiment of the present invention;

FIGS. 4A to 4C are schematic diagram to explain a method for providing a menu of a remote controller according to an exemplary embodiment of the present invention;

FIG. 5 is a flow chart to explain a method for providing a menu of a remote controller according to an exemplary embodiment of the present invention; and

FIG. 6 is a flow chart to explain a method for setting a menu of a remote controller according to an exemplary embodiment of the present invention.

### DETAILED DESCRIPTION OF EXEMPLARY EMBODIMENTS OF THE INVENTION

Certain exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

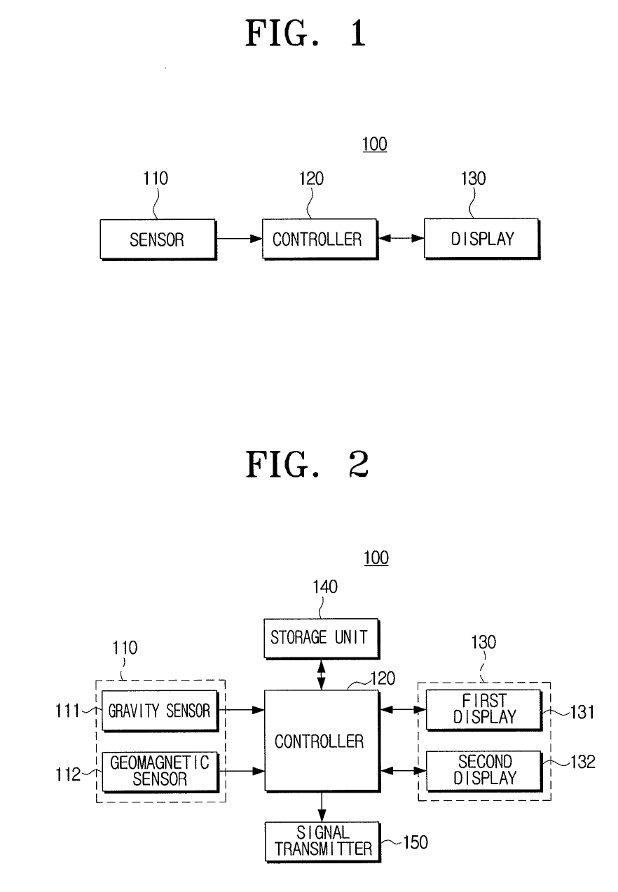

FIG. 1 is a block diagram illustrating a remote controller according to an exemplary embodiment of the present invention. Referring to FIG. 1, a remote controller 100 may comprise a sensor 110, a controller 120, and a display 130.

The sensor 110 senses a gripping direction in which a fore end of the remote controller 100 faces, and provides the controller 120 with the sensed gripping direction. The sensor 110 may be a gravity sensor and a geomagnetic sensor.

The gravity sensor is used to distinguish upper and lower parts of the remote controller 100, and the geomagnetic sensor is used to compute an azimuth angle according to rotation of the remote controller 100, and to detect a forwarding direction in which the fore end of the remote controller 100 faces.

The gripping direction is divided into a first direction in the range of −45° to 45°, a second direction in the range of 45° to 135°, a third direction in the range of 135° to 225°, and a fourth direction in the range of 225° to 315°, with respect to the forwarding direction of the fore end of the remote controller 100.

If the upper and lower directions of the remote controller 100 are reversed, the gripping direction is divided into a fifth direction in the range of −45° to 45°, a sixth direction in the range of 45° to 135°, a seventh direction in the range of 135° to 225°, and an eighth direction in the range of 225° to 315°, with respect to the forward direction of the reversed remote controller 100. The fore end of the remote controller 100 means an end of the remote controller 100 in which a user manipulates the remote controller 100 in order to forward a signal to the electronic device to control the electronic device.

The controller 120 controls the display 130 to display a control menu of an external apparatus corresponding the gripping direction sensed and provided from the sensor 110.

The display 130 may be formed on one of upper and lower surfaces of the remote controller 100, and display one of the control menus of the plurality of external apparatuses under the control of the controller 120. The display 130 may be a touch screen panel.

FIG. 2 is block diagram illustrating the remote controller of FIG. 1 in detail. Referring to FIG. 2, the remote controller 100 may further comprise a storage unit 140 and a signal transmitter 150.

The display 130 may comprise a first display 131 which is formed on one surface of the remote controller 100, and a second display 132 which is formed on an opposed surface of the first display 131.

The sensor 110 may comprise a gravity sensor 111 which senses the display corresponding to the upper surface of the remote controller 100 among the first and second displays 131 and 132, and provides the controller 120 with the sensed result, and a geomagnetic sensor 112 which senses the gripping direction of the remote controller 100.

The geomagnetic sensor 112 measures the power and direction of the magnetic field of the earth which cannot be perceived by humans, and converts the measured magnetic power and direction into an electrical signal. The geomagnetic sensor 112 housed in the remote controller 100 detects terrestrial magnetism to measure a rotation degree of the remote controller body. That is, the geomagnetic sensor 112 measures a rotation angle or an azimuth angle with respect to a vertical axis of the remote controller 100 to earth, and transmits the measured angles to the controller 120. The rotation angle may be measured in a clockwise direction with reference to the north as 0 degree.

The geomagnetic sensor 112 comprises two fluxgates, each being in X axis and Y axis directions, and made of magnetic cores. A driving coil and a detecting coil are wound around each of the magnetic cores. If the remote controller 100 moves, a driving pulse is input to the driving coils, the fluxgates magnetize, and electromotive force (EMF) is detected through the detecting coil.

The detected EMF is converted into a digital format, and the digitized EMF is output. The output value is mapped into a predetermined range by the normalization process. The rotation angle of the remote controller 100 is measured using the output values of the normalized X and Y axes. The rotation angle Ψ may be tan⁻¹(Y axis output value/X axis output value).

To process the normalization in which digital values are mapped in the predetermined range, a fabricator which fabricates the geomagnetic sensor 112 rotates the geomagnetic sensor 112 horizontally at least once in advance to output the output values of X and Y axes of the fluxgate. When the measurement is completed, the maximum value and minimum value are selected from the measured output values, and the selected values are stored at the storage unit 140.

The geomagnetic sensor 112 substitutes the stored maximum and minimum values and the detected the output values of X and Y axes with Formula 1 to perform the normalization.

$$Xn = \frac{X - {X}_{bias}}{{X}_{scale}} , \\ {X}_{bias} = \frac{{X}_{max} + {X}_{min}}{2} , \\ {X}_{Scale} = \frac{{X}_{max} - {X}_{min}}{2} \\ Yn = \frac{Y - {Y}_{bias}}{{Y}_{scale}} , \\ {Y}_{bias} = \frac{{Y}_{max} + {Y}_{min}}{2} , \\ {Y}_{Scale} = \frac{{Y}_{max} - {Y}_{min}}{2} \qquad [ Formula 1 ]$$

where,
X, Y=fluxgate 121 of X axis, fluxgate 123 of Y axis
Xₙ, Yₙ, =normalization value of X, normalization value of Y
Xₘₐₓ, Xₘᵢₙ=maximum value of X, minimum value of X
Yₘₐₓ, Yₘᵢₙ=maximum value of Y, minimum value of Y

A terrestrial magnetism operator substitutes Xₘₐₓ, Xₘᵢₙ, Yₘₐₓ, and Yₘᵢₙ with Formula 1 to compute X_{bias}, X_{scale}, Y_{bias}, and Y_{scale}, and computes Xₙ, and Yₙ using X_{bias}, X_{scale}, Y_{bias}, and Y_{scale}.

The function values of tan⁻¹ range from 0° to 90° in the first quadrant, from −90° to +90° in the second and third quadrants, and from −90° to 0° in the fourth quadrant. Accordingly, the geomagnetic sensor 112 computes the rotation angle according to Formula 2 to represent all the range of 0° to 360°.

first quadrant: rotation angle=tan⁻¹(Y/X) second and third quadrants: rotation angle=180°+tan⁻¹ (Y/X) fourth quadrant: rotation angle=360°+tan⁻¹(Y/X) [Formula 2]
where,
X, Y=output value of X, output value of Y

The rotation value computed at the geomagnetic sensor 112 is input to the controller 120.

The controller 120 obtains the rotation angle transmitted from the geomagnetic sensor 112, and extracts the control menu of the external apparatus corresponding to the obtained angle from the storage unit 140. The storage unit 140 pre-stores a rotation angle of a predetermined range and the control menu of the external apparatus corresponding to the rotation angle.

The rotation angle of the predetermined range stored at the storage unit 140 may range 45° between left and right directions with respect to a gripping direction. Accordingly, the control menus for maximum 8 external apparatuses may be provided. The external apparatus may include televisions (TV), air conditioners, lightings, and home theaters, which constitute a home network.

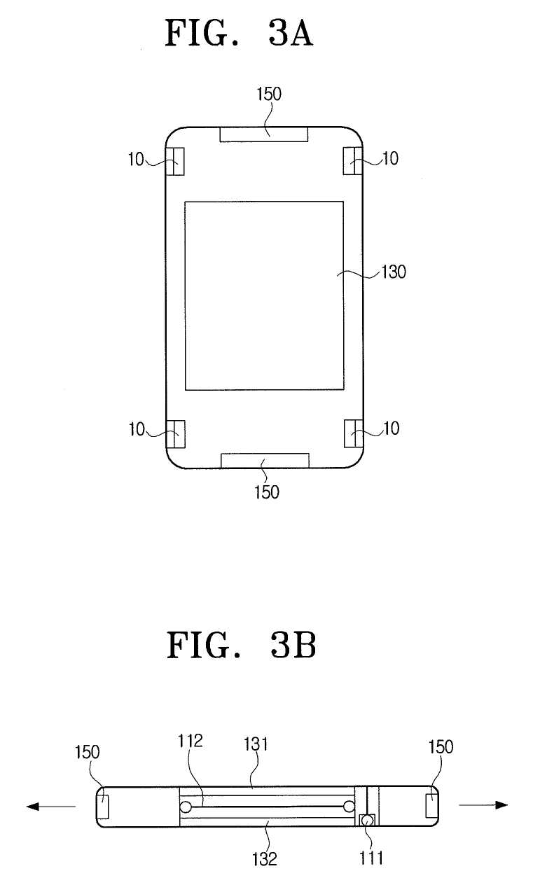

FIGS. 3A and 3B illustrate the structure of the remote controller 100.

FIG. 3A illustrates the structure of an upper or lower portion of a remote controller, and FIG. 3B illustrates the inner structure shown at a side view. Referring to FIG. 3A, the remote controller 100 may comprise a plurality of power buttons 10 and the display 130. The plurality of signal transmitters 150 are provided on all the side surfaces.

The plurality of power buttons 10 are provided on the side surface of the remote controller 100. The respective power buttons 10 provide the function to turn on or off the remote controller 100. The plurality of power buttons 10 are provided, a left-hander or right-hander may conveniently use the remote controller 100 by selecting one of the power buttons 10. Also, a user can readily use the power buttons 10 of the remote controller 10 irrespective to the gripping direction of the remote controller 100. The power buttons 10 may be recessed by the depth of approximately 0.3 cm to avoid being pressed unintentionally.

If the power button 10 is input, the controller 120 may provide a basic mode. The basic mode provides a menu which enables a user to select the control menu of the external apparatus according to the menu, and a setting mode which enables a user to set the control menu of the external apparatus according to the gripping direction.

If the setting mode is selected, the user may set the control menu of the external apparatus according to the gripping direction. The setting mode provides a list to select the external apparatus connected with the home network. That is, if one of the external apparatuses is selected using the setting mode in the current gripping direction, the controller 120 matches the current gripping direction with the control menu of the selected external apparatus to store in the storage unit 140.

If the user rotates the remote controller 100 without selecting the menu in the basic mode, the controller 120 displays the control menu of the external apparatus according to the gripping direction on the display 130 which corresponds to the external apparatus.

Referring to FIG. 3B, the remote controller 100 may comprise the first display 131, the second display 132, the signal transmitter 150, the gravity sensor 111, and the geomagnetic sensor 112. The first display 131 is provided on the upper surface, the second display 132 is provided on the lower surface, the signal transmitter 150 is provided on the side surface, and the gravity sensor 111 and the geomagnetic sensor 112 are provided in the inside.

The remote controller 100 is connected with the second display 132 by the additional gravity of the gravity sensor 111. If a reference angle refers the first display 131, an inclined angle is computed within a predefined error tolerance of 180°, and the signal corresponding to the computed inclined angle is transmitted to the controller 120. Accordingly, the controller 120 may detect that the first display 131 is an upper surface of the remote controller 100.

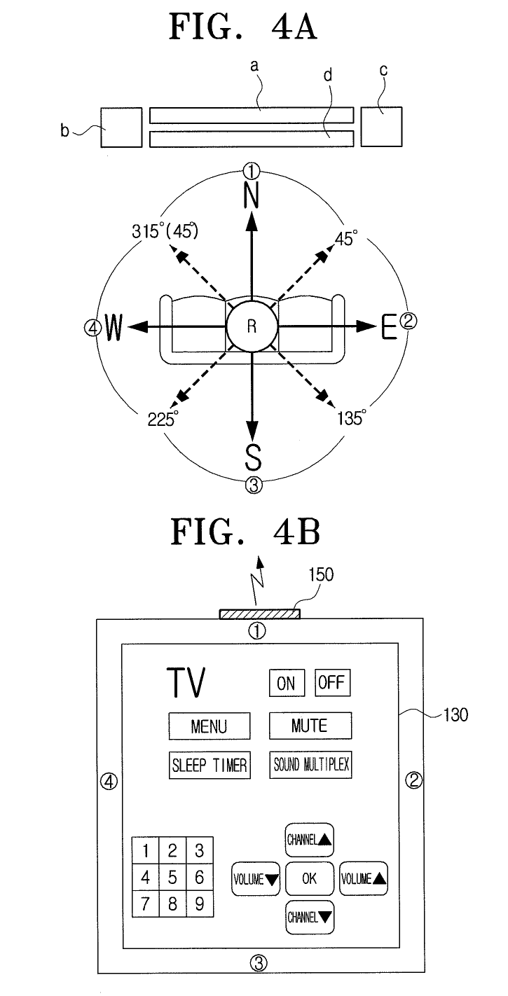

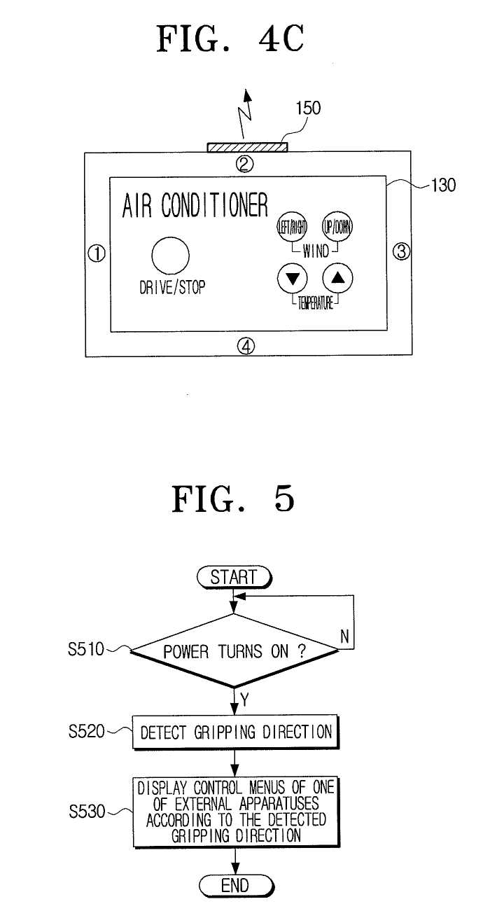

The control menu display of the controller 120 according to the gripping direction of the remote controller 100 will be explained with reference to FIGS. 4A through 4C.

FIGS. 4A through 4C are schematic diagrams to explain a method for providing menus of a remote controller according to an exemplary embodiment of the present invention.

Referring to FIG. 4A, a plurality of external apparatuses (a, b, c, and d) are disposed in the other area of a remote controller (R), that is, formed on the opposite side to a user.

The rotation angle of the remote controller (R) may be measured in a clockwise direction, assuming that the north is 0° . The gripping direction is divided into a first direction 1 in the range of −45° to 45°, a second direction 2 in the range of 45° to 135°, a third direction 3 in the range of 135° to 225°, and a fourth direction 4 in the range of 225° to 315°, with respect to the forward direction of the remote controller 100.

FIG. 4B illustrates control menus corresponding to the first direction 1, and FIG. 4C illustrates control menus corresponding to the second direction 2. Referring to FIG. 4B, the gripping direction is detected as the first direction 1, the control menus of a TV corresponding to the first direction 1 are displayed, and control signals are transmitted to the TV through the signal transmitter 150 of the first direction 1. Referring to FIG. 4C, the gripping direction is detected as the second direction 2, the control menus of a air conditioner corresponding to the second direction 2 are displayed, and control signals are transmitted to the air conditioner through the signal transmitter 150 of the second direction 2.

FIGS. 4A to 4C illustrate the process of changing the menu display when the remote controller (R) rotates horizontally. However, when the remote controller (R) rotates in a vertical direction, control menus corresponding to one of fifth to eighth directions may be displayed in the above mentioned manner.

FIG. 5 is a flow chart to explain a method for providing a menu of a remote controller according to an exemplary embodiment of the present invention. A remote controller stores control menus to control a plurality of external apparatuses, comprises a first display and a second display to display control menus on an upper or lower surface.

If the power of the remote controller turns on (S510), the gripping direction of the remote controller is detected (S520).

The gripping direction is detected with reference to the gravity and geomagnetic sensors. The gravity sensor detects whether the surface having the first display or the surface having the second display corresponds to the upper surface of the remote controller, the geomagnetic sensor detects the gripping direction, i.e. a forwarding direction in which the fore end of the remote controller faces. The detailed descriptions were explained with reference to FIGS. 2 to 5, and thus which will be omitted.

The control menus of one of the external apparatuses are displayed according to the detected gripping direction (S530).

The gripping direction is divided into a first direction in the range of −45° to 45°, a second direction in the range of 45° to 135°, a third direction in the range of 135° to 225°, and a fourth direction in the range of 225° to 315°, with respect to the forward direction of the remote controller 100. If a face and reverse of the remote controller 100 are turned, the gripping direction is divided into a fifth direction in the range of −45° to 45°, a sixth direction in the range of 45° to 135°, a seventh direction in the range of 135° to 225°, and an eighth direction in the range of 225° to 315°, with respect to the forward direction of the reversed remote controller 100. If more apparatuses are provided, the gripping direction may be divided into more directions.

The input of the control menu may be input in a touch screen manner, and the control signal corresponding to the input menu may be transmitted to the external apparatus.

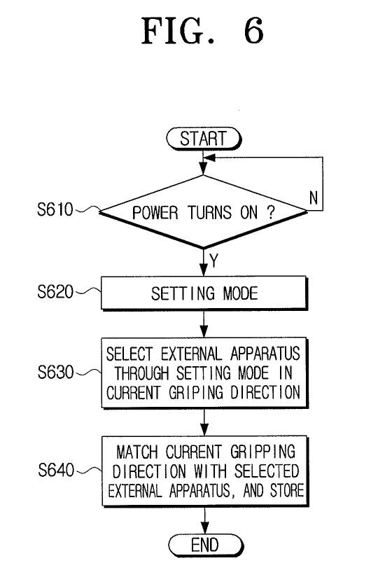

FIG. 6 is a flow chart to explain a method for setting a menu of a remote controller according to an exemplary embodiment of the present invention. Referring to FIG. 6, if the power of the remote controller turns on (S610), the remote controller may provide a basic mode through the display.

The basic mode provides a menu which enables a user to select the control menu of the external apparatus according to the menu, and a setting mode which enables a user to set the control menu of the external apparatus according to the gripping direction.

If the setting mode is selected (S620), the user may set the control menu of the external apparatus according to the gripping direction. The setting mode provides a list to select the external apparatus connected with the home network.

If one of the external apparatuses is selected through the setting mode in the current griping direction (S630), the setting of the control menu according to the gripping direction is set (S640).

If the user rotates the remote controller without selecting the menu on the basic mode, the control menus of the predefined external apparatus are displayed on the display corresponding the external apparatus. Accordingly, the user sets and uses the control menu in a simple manner.

The remote controller according to the present invention provides control menus to control a plurality of devices according to the gripping direction. Therefore, a user can control a plurality of external apparatuses using one remote controller, and the control menus are provided by a user's simple setting without searching the control menus of the external apparatuses.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A remote controller for controlling a plurality of external apparatuses, the remote controller comprising:
a display;
a sensor which senses a gripping direction of the remote controller in which a fore end of the remote controller faces;
a controller which displays at least one control menu of one of the plurality of external apparatuses on the display according to the sensed gripping direction.

2. The remote controller of claim 1, wherein the display comprises:
a first display which is formed on a first surface of the remote controller; and
a second display which is formed on a second surface of the remote controller,
wherein the controller displays the at least one control menu corresponding to the sensed gripping direction on the first display or the second display that faces an upper surface of the remote controller.

3. The remote controller of claim 2, wherein the sensor comprises:
a gravity sensor which senses the display that faces the upper surface of the remote controller among the first display and the second display; and
a geomagnetic sensor which senses the gripping direction.

4. The remote controller of claim 1, further comprising:
a storage unit which stores the at least one control menu of each of the plurality of external apparatuses,
wherein the controller provides a setting mode to set the at least one control menu of each of the plurality of external apparatuses according to the gripping direction, and if one of the plurality of external apparatuses is selected through the setting mode in the current gripping direction, the controller matches the gripping direction with the at least one control menu of the selected external apparatus to store.

5. The remote controller of claim 3, wherein the gripping direction comprises a first direction in the range of −45° to 45°, a second direction in the range of 45° to 135°, a third direction in the range of 135° to 225°, and a fourth direction in the range of 225° to 315°, with respect to the forwarding direction of the fore end of the remote controller 100 when the first display faces the upper surface of the remote controller, and the gripping direction comprises a fifth direction in the range of −45° to 45°, a sixth direction in the range of 45° to 135°, a seventh direction in the range of 135° to 225°, and an eighth direction in the range of 225° to 315°, with respect to the forward direction of the remote controller when the second display faces the upper surface of the remote controller.

6. The remote controller of claim 1, further comprising:
a plurality of signal transmitters which are provided on each of all surfaces of the remote controller, and which transmit a control signal to the one of the plurality of external apparatuses corresponding to the gripping direction.

7. The remote controller of claim 1, wherein the display is a touch screen panel.

8. A method for providing menus of a remote controller to control a plurality of external apparatuses, the method comprising:
sensing a gripping direction of the remote controller in which a fore end of the remote controller faces; and
displaying at least one control menu of one of the plurality of external apparatuses according to the sensed gripping direction.

9. The method of claim 8, wherein the displaying comprises;
displaying the at least one control menu corresponding to the sensed gripping direction on a display corresponding to an upper surface of the remote controller among a first display provided on a first surface of the remote controller and a second display provided on a second surface of the remote controller.

10. The method of claim 9, wherein the sensing comprises:
first-sensing the first display or second display that faces the upper surface of the remote controller; and
second-sensing the gripping direction in which a fore end of the remote controller faces.

11. The method of claim 8, further comprising;
providing a setting mode to receive the at least one control menu of each of the plurality of external apparatus according to the gripping direction;
selecting one of the plurality of external apparatuses through the setting mode in the current gripping direction; and
matching the current gripping direction with the at least one control menu of the selected external apparatus to store.

12. The method of claim 10, wherein the gripping direction comprises a first direction in the range of −45° to 45°, a second direction in the range of 45° to 135°, a third direction in the range of 135° to 225°, and a fourth direction in the range of 225° to 315°, with respect to the forwarding direction of the fore end of the remote controller 100 when the first display faces the upper surface of the remote controller, and the gripping direction comprises a fifth direction in the range of −45° to 45°, a sixth direction in the range of 45° to 135°, a seventh direction in the range of 135° to 225°, and an eighth direction in the range of 225° to 315°, with respect to the forward direction of the reversed remote controller when the second display faces the upper surface of the remote controller.

13. The method of claim 8, wherein an input of the control menus to be displayed is a touch screen manner.

14. The remote controller of claim 1, wherein the fore end of the remote controller corresponds to an end of the remote controller by which a user manipulates the remote controller in order to forward a signal to the one of the plurality of electronic devices to control the one of the plurality of electronic devices.

15. The method of claim 9, wherein the fore end of the remote controller corresponds to an end of the remote controller by which a user manipulates the remote controller in order to forward a signal to the one of the plurality of electronic devices to control the one of the plurality of electronic devices.
